(19) United States
(12) Patent Application Publication
(10) Pub. No.: US 2025/0338979 A1
(43) Pub. Date: Nov. 6, 2025

(54) Eyeglasses Holder Apparatus

(71) Applicants: Dana Layne Johnson, Athens, OH (US); Todd Eric Johnson, New Market, MN (US)

(72) Inventors: Dana Layne Johnson, Athens, OH (US); Todd Eric Johnson, New Market, MN (US)

(21) Appl. No.: 19/087,177

(22) Filed: Mar. 21, 2025

Related U.S. Application Data
(60) Provisional application No. 63/642,515, filed on May 3, 2024.

(51) Int. Cl. A47F 7/02; F16B 47/00; F16M 11/14; F16M 13/02

(52) U.S. Cl. CPC A47F 7/021; F16M 11/14; F16M 13/022; F16B 47/00; F16M 2200/06

(57) ABSTRACT

An eyeglasses holder apparatus including an attachment mechanism, a panel, and a tension member. The attachment mechanism removably couples to a structure, such as a vehicle window or frame. The adjustable attachment mechanism incorporates a ball joint and an optional clamping or suction mechanism for stability. The panel, a rectangular structure with front and rear surfaces, including a plurality of notches along its minor sides and a central cutout with a tab. The tension member extends between the notches and behind the tab, securing eyeglasses by holding the temples in tension between the panel and the tension member. The panel is composed of plexiglass and fastened to the attachment mechanism using screws, rivets, or adhesive.

### FIELD OF THE INVENTION

The present invention relates generally to an eyeglasses holder apparatus. More specifically, the present invention is an eyeglasses holder apparatus using tension and suction to hold glasses.

### BACKGROUND OF THE INVENTION

Eyeglasses, commonly comprising lenses set in frames with temples, are delicate items requiring careful handling and storage to prevent damage. The temples, also known as arms, extend over the ears to hold the eyeglasses place on the wearer's face and are particularly prone to stress and damage if not stored properly. In the prior art, several methods and devices have been proposed to store eyeglasses in a manner that reduces the risk of damage and keeps them readily accessible.

Traditional storage solutions include cases, stands, and racks. While cases protect eyeglasses well, they often render the eyeglasses less accessible, as they must be opened and the eyeglasses removed, which can be inconvenient, especially for those who frequently switch between eyeglasses and no glasses. Stands and racks, on the other hand, provide easier access but typically offer less protection, particularly in environments where knocking the eyeglasses off the stand is a risk.

Furthermore, prior art solutions such as magnetic holders and clip-based systems also exist. Magnetic holders often lack the versatility to be mounted on a variety of surfaces, and their magnetic fields can potentially interfere with electronic devices. Clip-based systems can exert excessive pressure on the temples, leading to stress and potential deformation of the eyeglasses over time.

The present invention aims to overcome these drawbacks by providing a eyeglasses holder apparatus that is both secure and gentle on the eyewear. The apparatus is designed to offer an improved method of holding eyeglasses that protects them from being knocked over, does not apply harmful pressure to sensitive parts like the temples, and can be attached to various surfaces, allowing for greater versatility in usage.

The innovative eyeglasses holder apparatus of the present invention includes a suction cup, an arm, and a panel. The suction cup allows for the apparatus to be mounted on a variety of smooth surfaces, such as glass, mirrors, and metal, providing flexibility in placement. This feature is particularly advantageous in environments where space is limited or where traditional stands and cases are impractical. The suction cup further provides users with a eyeglasses holder to utilize in activities involving a boat, UTV, golf cart, and other vehicles.

The arm serves as a linkage between the suction cup and the panel, positioning the panel at a convenient height and angle for the user to place or retrieve their glasses.

This design consideration ensures that the eyeglasses are held securely yet remain easily accessible.

A key feature of the present invention is the tension member, typically an elastic band, which extends across the front face of the panel. The tension member is configured to hold the eyeglasses by securing the temples in tension against the panel. This arrangement avoids the direct contact stress on the temples typical of clips and clamps, thereby minimizing the risk of damage. The elastic nature of the tension member allows it to accommodate various temple widths and thicknesses, further enhancing the protective function of the device without sacrificing convenience.

In conclusion, the present invention provides a significant improvement over prior art by offering a secure, damage-resistant, and versatile storage solution for glasses. Its design addresses the common problems associated with the storage and handling of eyeglasses, making it a valuable accessory for eyeglass wearers. This innovative approach not only enhances the durability of eyeglasses but also contributes to a more convenient and accessible user experience.

### BRIEF DESCRIPTION OF THE DRAWINGS

FIG. 1 is a perspective view of the present invention.

FIG. 2 is a side view of the present invention.

FIG. 3 is a perspective view of an alternate embodiment of the present invention.

FIG. 4 is a front view of the present invention.

FIG. 5 is a rear perspective view of the panel of the present invention.

FIG. 6 is a chart of the fasteners of the present invention.

FIG. 7 is a perspective view of multiple eyeglasses removably coupled to the present invention.

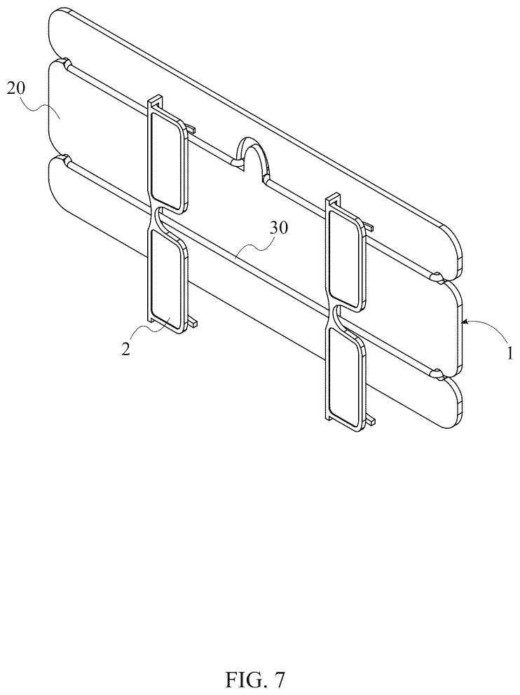

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of an eyeglasses holder apparatus 1, embodiments of the present disclosure are not limited to use only in this context.

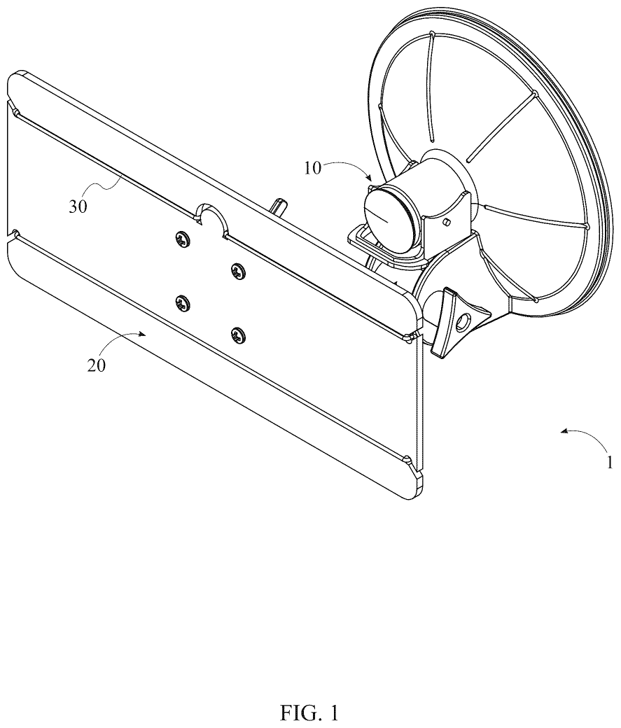

As shown in FIG. 1, the present invention is an eyeglasses holder apparatus 1 comprising an attachment mechanism 10, a panel 20, and a tension member 30. In the context of the present invention, the attachment mechanism 10 is coupled to the panel 20 and the tension member 30 extends across the panel 20. Furthermore, in the context of the present invention, the attachment member 10 removably couples to a structure. In some embodiments of the present invention the structure is a vehicle window, a vehicle frame, and structures of the like. Moreover, in the context of the present invention, the structure further includes any structure in which a user intends to couple the present invention.

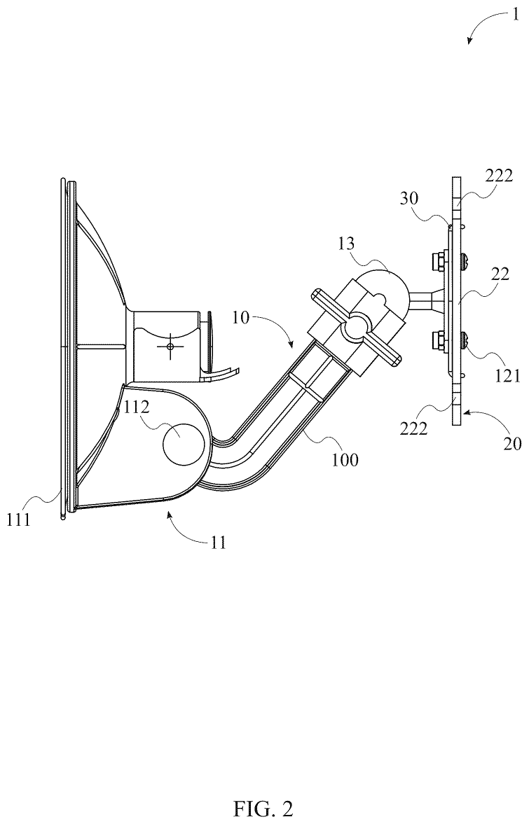

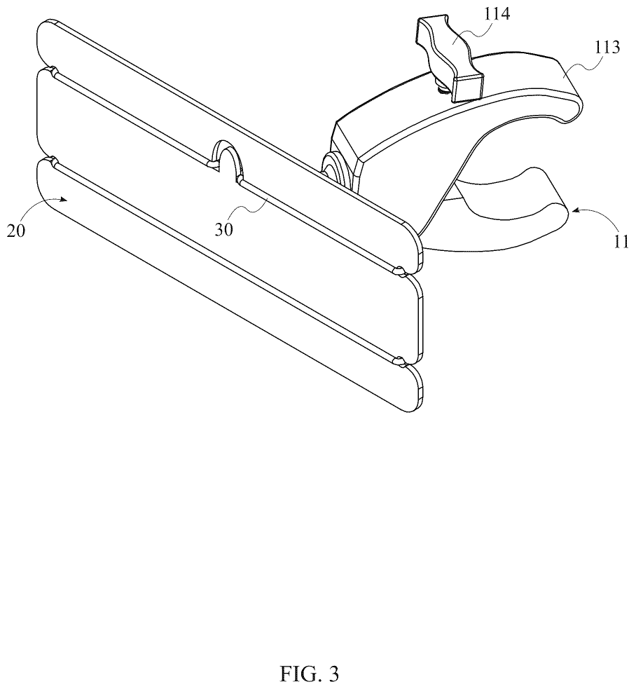

In some embodiments of the present invention, as shown in FIG. 2, the attachment mechanism 10 comprises an adjustable arm 100 comprising a base 11 and a ball joint 13 such that the base 11 and the ball joint 13 are positioned on opposing distal ends of the adjustable arm 100. In the preferred embodiment of the present invention, the panel 20 is coupled to the ball joint 13 such that the panel 20 freely rotates in relation to the adjustable arm 100. Furthermore, in the preferred embodiment of the present invention, the attachment mechanism 10 comprises a hinge 112 wherein said hinge 112 is interposed between the base 1111 and the adjustable arm 100, such that the base 11 is hingedly coupled to the adjustable arm 100. Additionally, in some embodiments of the present invention, the base 11 comprises a suction cup 111, as shown in FIG. 2. Alternatively, as shown in FIG. 3, in some embodiments of the present invention, the attachment mechanism 10 comprises a clamping mechanism 113. In the preferred embodiment, the clamping mechanism 113 further comprises a locking mechanism 114.

In the preferred embodiment of the present invention, the panel, as shown in FIG.

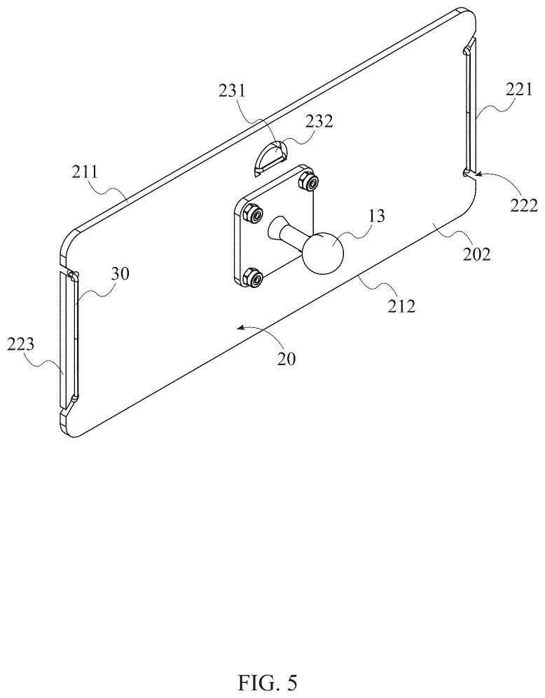

4 and FIG. 5, is a rectangular panel comprises a front surface 201, a rear surface 202, a plurality of major sides 21, and a plurality of minor sides 221,223. In the context of the present invention, the plurality of major sides 21 comprises a first major side 211 and a second major side 212, and the plurality of minor sides comprises a first minor side 221 and a second minor side 223, such that the plurality of major sides 21 are parallel to each other, the plurality of minor sides 221,223 are parallel to each other, and the plurality of major sides 21 and the plurality of minor sides 221,223 are perpendicular to each other. Furthermore, within the context of the present invention, the “major sides” are the longer sides of the rectangle wherein the “minor sides” are the shorter sides of the rectangle. Additionally, within the context of the present invention, the front surface 201 and rear surface 202 are opposing surfaces of the panel 20 such that the front surface 201 of the panel 20 is the forwardly facing surface of the panel 20, wherein the rear surface 202 is the rearward facing surface of the panel 20. In the preferred embodiment of the present invention, the attachment mechanism 10 extends from the rear surface 202 of the panel 20.

In the preferred embodiment of the present invention, the plurality of minor sides 221,223 comprises a plurality of notches 222. In the preferred embodiment of the present invention, each minor side comprises two notches. Furthermore, in the preferred embodiment of the present invention, the panel further comprises a cutout 231 and a tab 232, located at a central location on the panel 20, such that the cutout 231 is a small channel that forms the tab 232. In the preferred embodiment of the present invention, the tension member 30 traverses between the plurality of notches 222 of the plurality of minor sides 221,223 of the panel 20 such that that the tension member 30 extends tautly along the front surface 201 of the panel 20 between notches of opposing minor sides, parallel to the plurality of major sides 21, while traversing along the rear surface 202 of the panel 20 between the plurality of notches 222 along the same minor side.

Furthermore, in the preferred embodiment of the present invention, the tension member 30 traverses through the cutout 231 of the panel 20, behind the tab 232, thus maintaining tension on the tension member 30, against the front surface 201 of said panel 20.

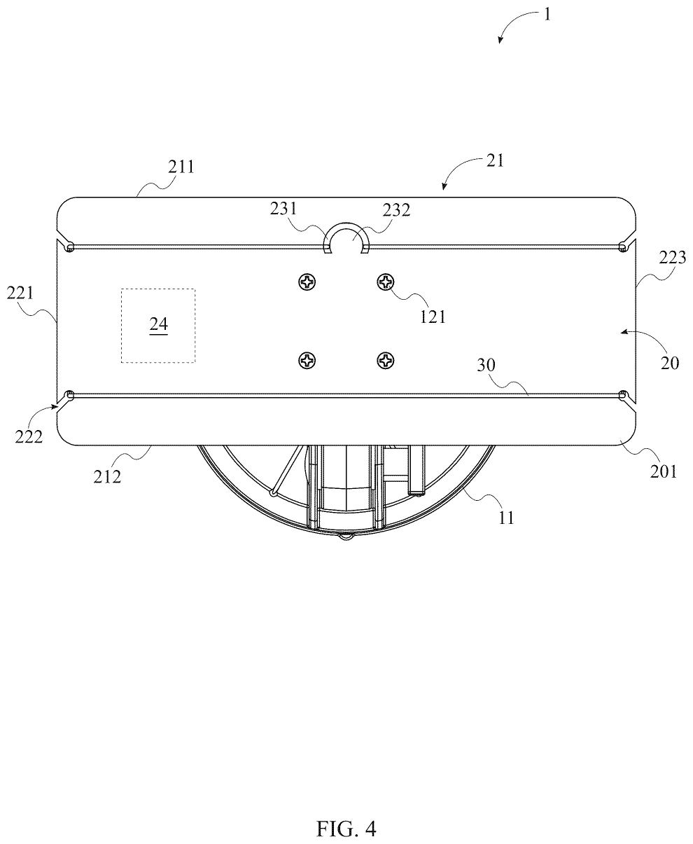

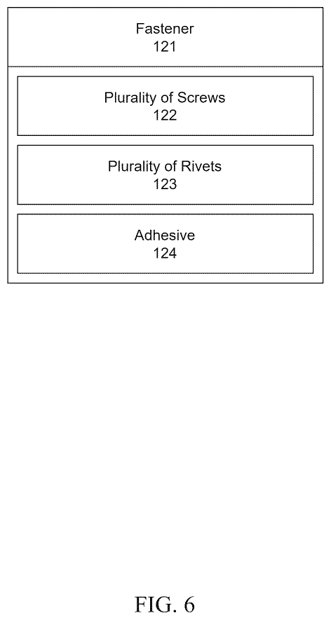

Furthermore, as shown in FIG. 4, the panel 20 is composed of a material 24 wherein said material 24 is a plexiglass material. Further, as shown in FIG. 5 and FIG. 6, the panel 20 is secured to the attachment mechanism through an at least one fastener 121 wherein said at least one fastener 121 is selected from a plurality of screws 122, a plurality of rivets 123, and an adhesive 124. In the preferred embodiment of the present invention, the plurality of screws 122 comprise four screws wherein said plurality of screws 122 are arranged in a [2×2] array. In such embodiments wherein the plurality of screws 122 are arranged in a [2×2] array, the screws are spaced 38 mm apart horizontally and 30 mm apart vertically. In the context of the present invention, “horizontally” is denoted as being aligned directionally (i.e. parallel) with the plurality of major sides 21, while “vertically” is denoted as being aligned directionally with the plurality of minor sides 221,223.

Furthermore, within the preferred embodiment of the present invention, the eyeglasses holder apparatus 1 may secure a plurality of eyeglasses 2 wherein said eyeglasses 2 comprise a frame having an at least one temple, wherein said temple is held in tension between the front surface 201 of the panel 20 and the tension member 30. Although the invention has been explained in relation to its preferred embodiment, it is to be understood that many other possible modifications and variations can be made without departing from the spirit and scope of the invention.

What is claimed is:

1. An eyeglasses holder apparatus comprising:
a panel;
an attachment mechanism; and
a tension member;
wherein:
the panel is coupled to the attachment mechanism; and
a portion of the tension member held tautly against a front surface of the panel.

2. The eyeglasses holder apparatus, as claimed in 1, wherein the panel further comprises:
a plurality of notches;
wherein:
the tension member extends between the plurality of notches.

3. The eyeglasses holder apparatus, as claimed in claim 2, wherein the panel is a rectangular plate comprising:
a plurality of major sides;
a plurality of minor sides;
wherein:
the plurality of major sides comprise a greater length than the plurality of minor sides;
the plurality of major sides comprises two parallel sides composing a length of the panel;
the plurality of minor sides comprises two parallel sides composing a height of the panel; and
the plurality of major sides being perpendicular to the plurality of minor sides.

4. The eyeglasses holder apparatus, as claimed in claim 3, wherein:
the plurality of notches are cut inwardly from the plurality of minor sides; and
the tension member extends laterally between the plurality of minor sides, parallel to the plurality of major sides.

5. The eyeglasses holder apparatus, as claimed in claim 3, wherein:
the panel further comprise a rear surface;
the rear surface being opposite the front surface of the panel;
the portion of the tension member extending along the front surface of the panel being parallel to the plurality of major sides; and
a portion of the tension member extending along the rear surface of the panel being parallel to the plurality of minor sides.

6. The eyeglasses holder apparatus, as claimed in claim 3, wherein:
the plurality of notches are cut inwardly from the plurality of minor sides such that each minor side comprises two notches;
the two notches on each minor side are offset from each other such that each minor side comprises an upper notch and a lower notch;
the plurality of notches of each minor side are aligned with plurality of notches of the opposite minor side;
the upper notch of each minor side is aligned;
the lower notch of each minor side is aligned;
a portion of the tension member extends tautly between the upper notches of each minor side along the front surface of the panel; and
a portion of the tension member extends tautly between the lower notches of each minor side along the front surface of the panel.

7. The eyeglasses holder apparatus, as claimed in claim 5, wherein:
the attachment mechanism is coupled to the rear surface of the panel;
the attachment mechanism further comprises:
a base; and
a ball joint;
wherein:
the ball joint is interposed between the base and the panel, enabling the panel to rotate freely.

8. The eyeglasses holder apparatus, as claimed in claim 7, wherein the base comprises a suction cup.

9. The eyeglasses holder apparatus, as claimed in claim 7, wherein the base comprises a clamp.

10. The eyeglasses holder apparatus, as claimed in claim 9, wherein the clamp further comprises a tightening mechanism.

11. The eyeglasses holder apparatus, as claimed in claim 7, wherein the panel is coupled to the attachment mechanism through one of:
a plurality of screws;
a plurality of rivets; and
an adhesive.

12. The eyeglasses holder apparatus, as claimed in claim 7, wherein the attachment mechanism further comprises an arm, wherein:
the arm is hingedly coupled to the base; and
the ball joint is positioned at a distal end of the arm, opposite the base.

13. The eyeglasses holder apparatus, as claimed in claim 2, wherein the panel further comprises a tab, wherein a portion of the tension member extends behind the tab.

14. An eyeglasses holder apparatus comprising:
an attachment mechanism;
a panel; and
a tension member;
wherein:
the panel is a rectangular member comprising a plurality of minor sides;
the plurality of minor sides comprise two parallel sides wherein said parallel sides compose opposing sides of the rectangular member;
each minor side comprises a plurality of notches including a first notch and a second notch, wherein said plurality of notches of each minor side are offset;
the first notch of each minor side being aligned to the respective first notch on the opposing minor side;
the second notch of each minor side being aligned being aligned to the respective second notch on the opposing minor side;
a portion of the tension member extending between the plurality of minor sides such that a portion of the tension member extends between the first notches, and a portion of the tension member extends between the second notches;
the attachment mechanism comprising a base; and
the base comprises a suction cup.

15. The eyeglasses holder apparatus, as claimed in claim 14, wherein the attachment mechanism, further comprises:
an arm; and
a ball joint;
wherein:
the attachment mechanism is coupled to a rear surface of the panel;
the base is hingedly attached to a distal end of the arm;
the ball joint is positioned on a distal end of the arm, opposite the base;
the ball joint is further coupled to the rear surface of the panel such that the panel freely rotates.

16. The eyeglasses holder apparatus, as claimed in claim 14, wherein the panel further comprise a tab;
a portion of the tension member extending behind the tab.

17. The eyeglasses holder apparatus, as claimed in claim 15 wherein the attachment mechanism is coupled to the panel by one of: a plurality of screws, a plurality of rivets, and an adhesive.

18. An eyeglasses holder apparatus comprising:
a panel;
an attachment mechanism; and
a tension member;
wherein:
the panel comprising a plurality of notches;
the panel is coupled to the attachment mechanism; and
the tension member extending through the plurality of notches such that a portion of the tension member held tautly against the front surface of the panel;
the attachment mechanism comprising a base; and
the base comprising a clamp.

19. The eyeglasses holder apparatus, as claimed in claim 18, wherein:
the panel further comprises a tab; and
a portion of the tension member extending behind the tab.

20. The eyeglasses holder apparatus, as claimed in claim 19, wherein:
the attachment mechanism further comprises a ball joint; and
the ball joint coupling to the panel such that the panel rotates freely.
